(19) United States
(12) Patent Application Publication
(10) Pub. No.: US 2025/0329139 A1
(43) Pub. Date: Oct. 23, 2025

(54) INFERENCE DEVICE AND INFERENCE METHOD

(71) Applicant: NEC Corporation, Tokyo (JP)

(72) Inventors: Kazutoshi HIROSE, Tokyo (JP); Taichi Ohtsuji, Tokyo (JP)

(73) Assignee: NEC Corporation, Tokyo (JP)

(21) Appl. No.: 19/176,442

(22) Filed: Apr. 11, 2025

(30) Foreign Application Priority Data
Apr. 23, 2024 (JP) 2024-069432

(51) Int. Cl. G06V 10/764; G06V 10/26; G06V 10/70; G06V 10/762; G06V 10/82

(52) U.S. Cl. CPC G06V 10/764; G06V 10/26; G06V 10/7625; G06V 10/87; G06V 10/82

(57) ABSTRACT

The inference device converting the resolution of an input image and performing inference, includes a clustering unit which clusters multiple classes to be classified into multiple upper classes, a resolution determination unit which determines a resolution corresponding to each of the multiple upper classes, a prediction unit which predicts the upper class to which the class to be classified in the input image belongs, a resolution converter which converts the resolution of the input image to a resolution corresponding to the predicted upper class, and a classifier which performs classification on the input image whose resolution has been converted.

### CROSS-REFERENCE TO RELATED APPLICATION

This application is based upon and claims the benefit of priority from the prior Japanese Patent Application No. 2024-069432, filed Apr. 23, 2024, the entire contents of which are incorporated herein by reference.

### BACKGROUND OF THE INVENTION

### Technical Field

This disclosure relates to an inference device and an inference method that performs inference by converting the resolution of an input image.

### Description of the Related Art

Non-patent literature 1 describes a neural network that transforms (resizes) the resolution of an input image to reduce the computational load when performing inference on the input image. The converted resolution is a resolution at which inference accuracy can be maintained. One inference about an input image is the classification of objects (samples) in the input image. Generally, the conversion of resolution is to reduce the resolution while maintaining inference accuracy. Non-patent literature 1 introduces that a sample such as a panda can be correctly predicted even at low resolution, but a sample that is easily blended with the background, such as a string dragonfly, can only be correctly classified at high resolution.

The neural network described in non-patent literature 1 includes a resolution predictor and an image classifier. The resolution predictor is pre-trained with images of various resolutions. During the inference phase, the resolution predictor predicts the minimum resolution for the input image at which the image classifier can perform inference without degrading inference accuracy. After the resolution of the input image is converted to the predicted resolution, the input image with the converted resolution is input to the image classifier. The image classifier performs inference based on said input image.

### CITATION LIST

### Non-Patent Literature

[Non-Patent Literature 1] Mingjian Zhu, et al, “Dynamic Resolution Network”, NeurIPS 2021 Conference Submissions

### SUMMARY OF THE INVENTION

In the neural network described in non-patent literature 1, it is difficult for the resolution predictor to predict the optimal resolution for all input images. The reason is that it is difficult for the resolution predictor to learn the appropriate resolution for each image over all the various images. In other words, it is difficult to maintain high prediction accuracy for resolution prediction across all input images.

The purpose of the present invention is to provide an inference device and an inference method that can maintain high prediction accuracy of resolution prediction over all input images.

The inference device based on the present disclosure is an inference device that converts a resolution of an input image and performs inference, includes clustering means for clustering multiple classes to be classified into multiple upper classes, resolution determination means for determining a resolution corresponding to each of the multiple upper classes, prediction means for predicting the upper class to which the class to be classified in the input image belongs, resolution conversion means for converting the resolution of the input image to a resolution corresponding to the predicted upper class, and classification means for performing classification on the input image whose resolution has been converted.

The inference method based on the present disclosure is a method for converting a resolution of an input image and performing inference, includes clustering multiple classes to be classified into multiple upper classes, determining a resolution corresponding to each of the multiple upper classes, predicting the upper class to which the class to be classified in the input image belongs, converting the resolution of the input image to a resolution corresponding to the predicted upper class, and performing classification on the input image whose resolution has been converted.

The inference program based on the present disclosure is an inference program for converting the resolution of an input image and performing inference and for causing a computer to execute clustering multiple classes to be classified into multiple upper classes, determining a resolution corresponding to each of the multiple upper classes, predicting the upper class to which the class to be classified in the input image belongs, converting the resolution of the input image to a resolution corresponding to the predicted upper class, and performing classification on the input image whose resolution has been converted.

According to the invention, the prediction accuracy of resolution prediction can be kept high over all input images.

### BRIEF DESCRIPTION OF THE DRAWINGS

FIG. 1 It depicts a block diagram showing an example configuration of an inference device.

FIG. 2A It depicts an explanatory diagram showing an example of inference accuracy for each input resolution for a classifier.

FIG. 2B It depicts an explanatory diagram showing an example of inference accuracy for each input resolution for a classifier.

FIG. 3 It depicts a flowchart showing an example of the operation of an inference device in the training phase.

FIG. 4 It depicts a flowchart showing an example of the operation of an inference device in the inference phase.

FIG. 5 It depicts a flowchart showing another example of the operation of an inference device in the training phase.

FIG. 6 It depicts a block diagram showing another example configuration of an inference device.

FIG. 7 It depicts a flowchart showing another example of the operation of an inference device in the inference phase.

FIG. 8 It depicts an explanatory diagram showing an example configuration of a wireless sensing system.

FIG. 9A It depicts an explanatory diagram showing how to adjust the number of dimensions of an output from the classifier.

FIG. 9B It depicts an explanatory diagram showing how to adjust the number of dimensions of an output from the classifier.

FIG. 9C It depicts an explanatory diagram showing how to adjust the number of dimensions of an output from the classifier.

FIG. 10 It depicts a block diagram showing an example of an information processing device.

FIG. 11 It depicts a block diagram showing the main part of the inference device.

### DESCRIPTION OF THE PREFERRED EMBODIMENTS

Hereinafter, example embodiments of the present invention will be explained with reference to the drawings.

### First Example Embodiment

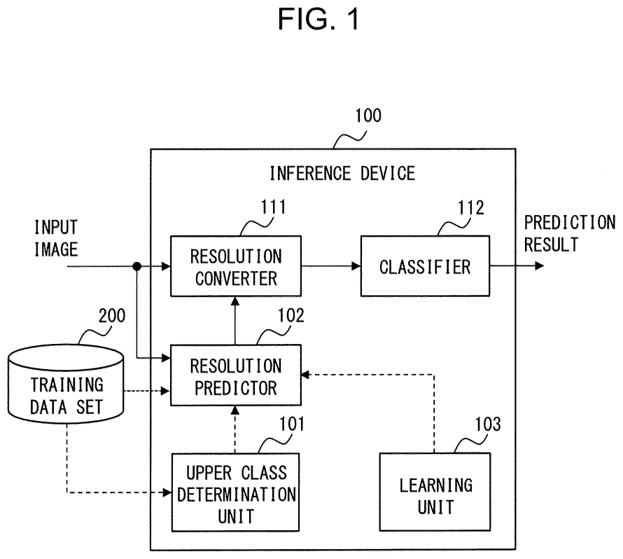

FIG. 1 is a block diagram showing an example configuration of an inference device of an example embodiment. The inference device 100 shown in FIG. 1 has an upper class determination unit 101, a resolution predictor 102 composed of a neural network, for example, a learning unit 103, a resolution converter 111, and a classifier 112 composed of a neural network, for example. The inference device 100 is primarily a device for classifying objects in an input image, i.e., objects in an image.

The arrows in FIG. 1 simply indicate the direction of signal (data) flow, but do not preclude bidirectionality. This is also true for the other block diagrams. In FIG. 1, the dashed arrows indicate the flow of signals (data) in the training phase, and the solid arrows indicate the flow of signals (data) in the inference phase.

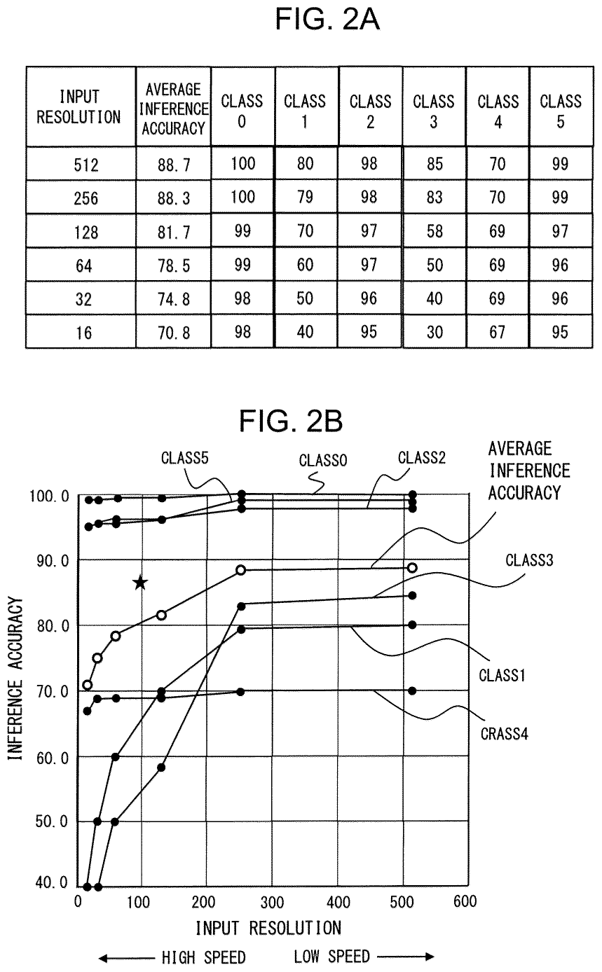

First, the concept of the present disclosure is explained. FIGS. 2A and 2B are explanatory diagrams showing an example of inference accuracy for each input resolution for the classifier 112 in the inference device 100. The input resolution in FIGS. 2A and 2B is a resolution of the input image input to the classifier 112.

In FIG. 2A, class n (n=0-5) corresponds to a classification target. Classification targets are, as an example, a dog, a cat, an airplane, an apple, etc. The line corresponding to each of the multiple resolutions (512, 256, 128, 64, 32, and 16 in the example in FIG. 2A) illustrates inference accuracy for each class. The average inference accuracy is an average of the inference accuracies for classes 0 through 5. For example, a resolution of m (m=512, 256, 128, 64, 32, or 16) means that the number of pixels in the width direction and the height direction of the image is m, assuming that the input image is a square. The resolution of m may also be defined as the number of pixels per given unit (for example, inches) in the width and height directions. In any case, a resolution with a higher numerical value is a higher resolution than a resolution with a lower numerical value. The resolution of 512 is the same as the resolution of the input image to the inference device 100, for example.

FIG. 2B shows a graphical representation of the inference accuracy for each input resolution illustrated in FIG. 2A. In general, the lower the input resolution, the greater the processing speed (inference speed) of the classifier 112.

Thus, the input resolution can be viewed as the inference speed.

In the example shown in FIG. 2B, for classes 0, 2, 4, and 5, inference accuracy does not decrease much as input resolution decreases. For classes 1 and 3, inference accuracy decreases as input resolution decreases.

Then, if classes 0-5 are clustered into multiple clusters and one resolution is assigned to each cluster, it may be possible to increase inference speed while preventing inference accuracy from decreasing. For example, for classes 0, 2, 4, and 5, since even if the input resolution is lowered, the inference accuracy does not decrease much, cluster them into a single cluster and lower the resolution for that cluster. For classes 1 and 3, since the inference accuracy decreases when the input resolution is lowered, they are clustered into other groups and the resolution corresponding to those clusters is increased. Hereinafter, the cluster is referred to as an upper class.

The upper class consisting of classes 0, 2, 4, and 5 is designated upper class A. The upper class consisting of classes 1 and 3 shall be upper class B. As an example, a resolution for upper class A is 16 and a resolution for upper class B is 256. Hereinafter, the resolution related to the upper classes may be referred to as upper resolution. In this example, the number of upper classes is 2, but the number of upper classes may be 3 or more. For example, when the user desires higher inference accuracy, the number of upper classes should be increased. For example, when the user wants to prioritize inference speed, the number of upper classes should be reduced.

In FIG. 2B, the average input resolution and average inference accuracy are indicated by a star when the upper class consisting of classes 0, 2, 4, and 5 is set as upper class A and the resolution for upper class A is set to 16, and the upper class consisting of classes 1 and 3 is set as upper class B and the resolution for upper class B is 256. The average inference accuracy is (98+95+67+95+79+83)/6=86.1. The average input resolution is (16×4+256×2)/6=96. As illustrated in FIG. 2B, the average inference accuracy when each class is clustered into an upper class is higher than the average inference accuracy when the input resolution is the same. In other words, the average input resolution when clustered is smaller than the input resolution corresponding to the average inference accuracy when the inference accuracy is the same.

### Process in Training Phase

The multiple candidate resolutions output by the resolution predictor 102 are set in advance by the user for example. The candidate resolutions are 512, 256, 128, 64, 32, and 16, as an example.

The inference accuracy for each input resolution is pre-computed when each of the resolution candidates is used as an input resolution. For example, the classifier 112 calculates inference accuracy for each class for each candidate resolution. When the candidate resolutions are 512, 256, 128, 64, 32, and 16, as in this example, the inference accuracy for each input resolution illustrated in FIG. 2B is obtained, for example. When the inference accuracy for each input resolution in the classifier 112 has already been obtained, it is not necessary to evaluate the inference result by the classifier 112 again.

In the inference device 100, the upper class determination unit 101 determines upper classes. The upper class determination is to determine a class that belongs to each of multiple upper classes. Take the case where the resolution candidates are 512, 256, 128, 64, 32, and 16, and the number of upper classes is 2. The upper class determination unit 101 determines the upper class for each combination of resolution candidates (in this example, two resolution candidates). In this example, since the number of resolution types is 6, there are ₆C₂=15 combinations of resolution candidates.

The following method of determining the upper class for a single candidate resolution combination is illustrated as an example. In the following example, the upper class A is an upper class with the lowest resolution, and the upper class B is an upper class with the highest resolution.

As an example, the upper class determination unit 101 clusters the class in which the inference accuracy calculated by the classifier 112 does not fall below a predetermined threshold when the input resolution becomes lower in a combination of candidate resolutions (in this example, two resolutions) into upper class A. The upper class determination unit 101 also clusters the classes whose inference accuracy becomes lower than the threshold value when the input resolution becomes lower to upper class B.

Taking the case where the candidate resolution combinations are 256 and 16, and the inference accuracy for each input resolution is obtained as illustrated in FIG. 2B, the classes 1 and 3 that are below 60 as a given threshold when the input resolution is less than 128 are clustered into upper class A, and classes 0, 2, 4 and 5 are clustered into upper class B.

The upper class determination unit 101 performs the above process on all candidate combinations of resolutions (in the above example, 15 candidate combinations of resolutions). As a result, clustering regarding the upper classes is performed for each of all candidate resolution combinations. It should be noted that the upper class A and the upper class B at this stage are not the final upper classes, but candidates for upper classes.

In the above example, the upper class determination unit 101 performed clustering regarding the upper classes using a threshold, but clustering regarding the upper classes may be performed by other methods, for example, using an evaluation function.

The upper class determination unit 101 may perform clustering on upper classes based on prior knowledge. For example, when one class (for example, dog) and another class (for example, cat) are so similar that it is difficult to distinguish them, they are clustered into the same upper class. The similarity is determined based on the feature vector, for example.

The upper class determination unit 101 may perform clustering on upper classes using the K-means method. When using the K-means method, the upper class determination unit 101 uses the difference in inference accuracy for each class over a combination of candidate resolutions for example.

In order to determine the resolution for each upper class, the upper class determination unit 101 performs the following process for each of all candidate combinations of resolutions.

That is, for each candidate combination of resolutions, the upper class determination unit 101 calculates an average input resolution and an average inference accuracy for all classes (for example, classes 0-5). As a result, the average input resolution and the average inference accuracy are obtained for all candidate resolution combinations. The inference accuracy for each resolution for each class is calculated by the classifier 112 to calculate the average input resolution and the average inference accuracy.

An example of average input resolution and average inference accuracy when the number of upper classes is 2, the resolution for upper class A is 16, and the resolution for upper class B is 256 corresponds to the average input resolution and the average inference accuracy indicated by the star in FIG. 2B. For example, when the number of candidate resolution combinations is 15, following the graph illustrated in FIG. 2B, 15 stars are plotted in the graph.

The upper class determination unit 101 selects one candidate combination of resolutions from all candidate combinations of resolutions. The upper class determination unit 101 makes each candidate resolution in the selected candidate combination of resolutions the final combination of resolutions given to the resolution predictor 102. The resolution combinations are determined in the above manner.

The following is an example of a method for selecting a single candidate resolution combination.

As an example, the upper class determination unit 101 selects the combination with the highest average inference accuracy among the combinations for which the average input resolution is below a predetermined value. Following the graph illustrated in FIG. 2B, the star with the highest average inference accuracy is selected among the stars whose average input resolution is below a predetermined value. As mentioned above, each star based on the average input resolution and the average inference accuracy of the multiple resolutions (for example, two resolutions) that comprise the combination of resolution candidates.

As another example, the upper class determination unit 101 uses an evaluation function such as (input resolution+λ inference accuracy) to select the combination of candidate resolutions that will give the highest value for the evaluation function.

The multiple resolutions that make up the determined resolution combination correspond to the upper classes. For example, when the determined resolution combination is 256 and 16, resolution 256 corresponds to upper class B and resolution 16 corresponds to upper class A. Therefore, the upper class determination unit 101 may supply the upper class labels to the resolution predictor 102 as information that can identify the resolution. The following is an example of a case where the upper class determination unit 101 supplies the upper class labels to the resolution predictor 102.

After completing the process of determining the upper classes and selecting the combination of resolutions (decision process) described above, the learning unit 103 instructs the resolution predictor 102 to start training to classify the image into one of the multiple upper classes. The resolution predictor 102 is a kind of learning model (prediction model).

In the inference device 100, a number of training data (training data sets) stored in advance in the training data storage unit 200 are sequentially supplied to the upper class determination unit 101 and the resolution predictor 102. Each of the training data is labeled. For example, a label corresponds to one of the above classes 0-5.

Specifically, in response to instructions from the learning unit 103, the resolution predictor 102 sequentially reads the training data from the training data storage unit 200. In addition, the upper class determination unit 101 reads labels corresponding to the training data read by the resolution predictor 102 from the training data storage unit 200.

The upper class determination unit 101 supplies the labels of the upper classes to which the labels (i.e., classes) of the training data belong to the resolution predictor 102. The resolution predictor 102 trains which of the multiple upper classes the image read from the training data storage unit 200 corresponds to. In other words, the resolution predictor 102 trains to classify the image into one of the multiple upper classes.

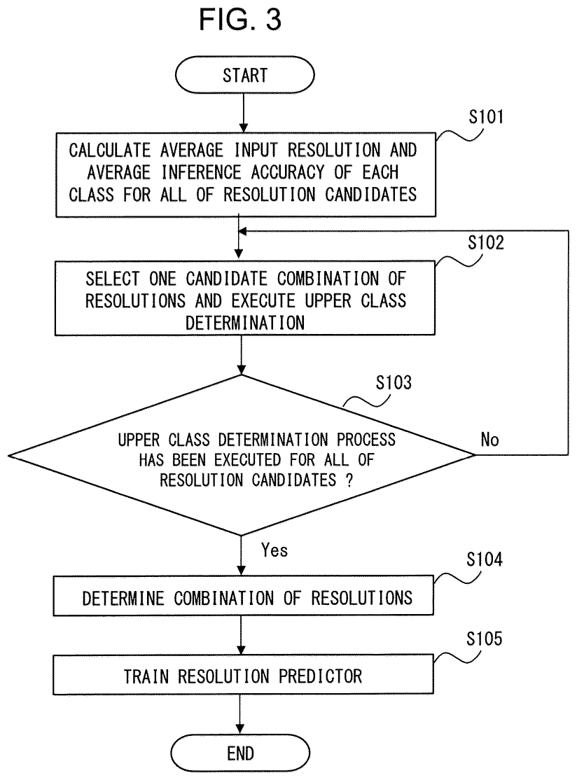

Next, operations of the upper class determination unit 101 and the resolution predictor 102 in the training phase will be explained with reference to the flowchart of FIG. 3.

For all of the predefined resolution candidates, inference accuracy of each class is calculated (step S101). As mentioned above, the inference accuracy of each class for all of the resolution candidates is calculated by the classifier 112, for example.

The upper class determination unit 101 selects one candidate combination of resolutions from all of the candidate resolutions and executes the upper class determination process described above for the selected candidate combination of resolutions (step S102). As mentioned above, the upper classes determined at this stage are the upper class candidates.

When the upper class determination process has been executed for all of the resolution candidates, the process moves to step S104 (step S103). When the upper class determination process has not yet been executed for all of the resolution candidates, the process returns to step S102 and the upper class determination process is executed for another combination of resolution candidates.

In step S104, the upper class determination unit 101 determines the final combination of resolutions. As described above, the upper class determination unit 101 calculates the average input resolution and average inference accuracy for all classes for each candidate combination of resolutions, and determines the final combination of resolutions based on the calculation results.

Next, the resolution predictor 102 trains to classify the image into one of several upper classes, as described above (step S105).

### Process in Inference Phase

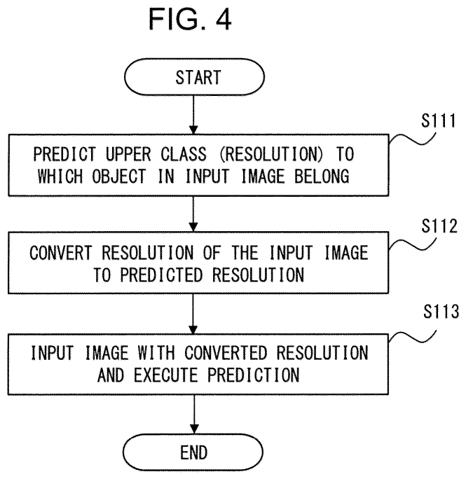

Next, the process in the inference phase will be explained with reference to FIG. 4. FIG. 4 is a flowchart showing an example of the operation of the inference device 100 in the inference phase.

In the inference device 100, an input image (for example, an image with a resolution of 512) is input to the resolution predictor 102 and the resolution converter 111.

In the inference device 100, the resolution predictor 102 predicts which upper class the object in the input image input to the inference device 100 belongs to (step S111).

The resolution predictor 102 outputs the resolution corresponding to the predicted upper class to the resolution converter 111. The resolution converter 111 converts the resolution of the input image input to the inference device 100 to the resolution corresponding to the predicted upper class (step S112). In step S112, the resolution converter 111 reduces the resolution when an upper class with a smaller resolution than the resolution of the input image is predicted. The resolution converter 111 can use pixel thinning or a max-pooling technique to reduce the resolution in the process of step S112.

The classifier 112 predicts the class using the input image with reduced resolution (step S113). The classifier 112 then outputs a prediction result. The output destination of the prediction result is a storage or a display device for example.

A general learning model that has already been trained can be used as the classifier 112. The learning model as the classifier 112 can also be trained using images of the resolution that could be used as training data.

As explained above, the inference device 100 clusters multiple classes into multiple clusters, assigns one resolution to each cluster, i.e., upper class, and converts the input image to the resolution corresponding to the cluster before making a prediction (for example, classification). For each of the multiple resolutions predetermined, the inference device 100 determines the resolution (the resolution corresponding to the cluster) that increases the average of the inference accuracy of the multiple classes (average inference accuracy). Thus, the inference device 100 can increase the inference speed while preventing a decrease in inference accuracy.

### Another Example of the First Example Embodiment

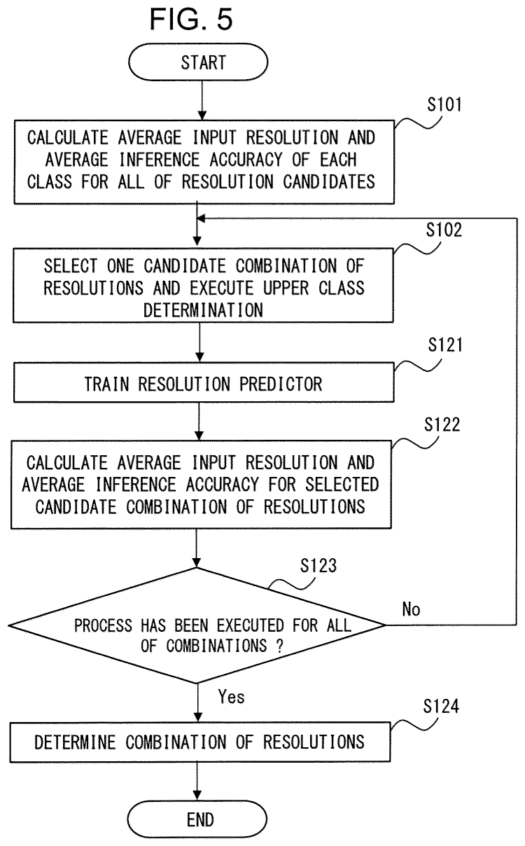

FIG. 5 is a flowchart showing another example of an operation of the inference device 100 in the training phase.

In the above example embodiment, after the upper class determination unit 101 performs the upper class determination process and the resolution predictor 102 trains about the resolution corresponding to each upper class, the resolution predictor 102 performs the prediction process for the appropriate resolution for the input image without learning (training) again. However, as shown in FIG. 5, the resolution predictor 102 may perform training at predetermined times during the training phase.

In this example, as in the above example embodiment, the inference accuracy of each class is calculated for all of the predefined candidate resolutions (step S101). The classifier 112 is configured to calculate and output the inference accuracy of each class for each resolution at predetermined timings in the training phase. The predetermined timing is during the upper class determination process or after training the resolution prediction predictor.

The upper class determination unit 101 selects one candidate combination of resolutions from all the candidate resolutions and executes the upper class determination process described above for the selected candidate combination of resolutions (step S102).

The resolution predictor 102 trains to classify the image into one of multiple upper classes (step S121). The process of step S121 corresponds to the process of step S105 in the above example embodiment.

Next, the average inference accuracy and the average inference speed that would be obtained by the classifier 112 are calculated (step S122) for each resolution comprising the combination of candidate resolutions selected in the process of step S102. In step S122, unlike the above example embodiment, the average inference accuracy and the average inference speed are obtained, for example, by actually operating the learned resolution predictor 102 and the classifier 112.

When the process of steps S102, S121, and S122 have been performed for all candidate combinations of resolutions, move to step S124. When there is a candidate combination of resolutions for which the process of steps S102, S121, and S122 have not yet been performed, return to step S102 and perform the process of steps S102, S121, and S122 for another candidate combination of resolutions.

In step S124, the upper class determination unit 101 determines the final combination of resolutions. For each candidate combination of resolutions, the upper class determination unit 101 determines the final combination of resolutions based on the average input resolution and the average inference accuracy values calculated in the process of step S122. As an example, the upper class determination unit 101 selects the combination with the highest average inference accuracy among the combinations with an average input resolution higher than a predetermined value. As another example, the upper class determination unit 101 uses an evaluation function such as (input resolution+λ inference accuracy) to select the combination of candidate resolutions with the highest value of the evaluation function.

The operation of the inference device 100 in this example in the inference phase is the same as the operation in the above example embodiment.

In this example, since the upper class determination unit 101 determines the final resolution combination by the average resolution and the average inference accuracy calculated using a prediction result of the resolution predictor, it is expected to improve the accuracy of the inference process (prediction process) by the classifier 112.

### Second Example Embodiment

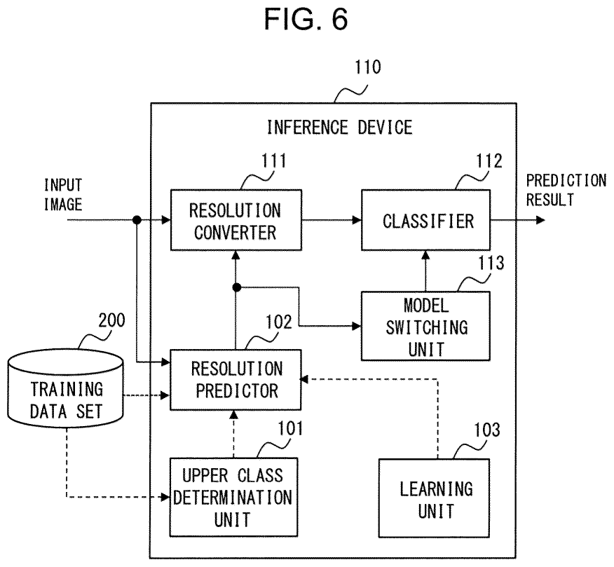

FIG. 6 is a block diagram showing an example configuration of an inference device. The inference device 110 shown in FIG. 6 has an upper class determination unit 101, a resolution predictor 102 composed of a neural network, for example, a learning unit 103, a resolution converter 111, a classifier 112 composed of a neural network, for example, and a model switching unit 113. The inference device 110 is primarily a device for classifying objects in the input image, i.e., objects in the image. The configurations and functions of the upper class determination unit 101, the resolution predictor 102, the learning unit 103, and the resolution converter 111 are the same as those in the first example embodiment.

In the first example embodiment, the classifier 112 in the inference device 100 is implemented with a single learning model. For example, when the number of upper classes is 2 and the number of classes is 6, the classifier 112 is a 6-class classification model corresponding to 2 resolutions.

However, the classifier 112 may comprise multiple learning models. For example, when the number of upper classes is 2 and the number of classes is 6, the classifier 112 may be configured with two learning models corresponding to each upper class. The reason why it may be configured in such a way is that the classes to be predicted for each resolution are fixed.

Based on the above concept, the classifier 112 is composed of multiple learning models in this example embodiment.

As an example, assume that the resolution corresponding to upper class A is 16 and the resolution corresponding to upper class B is 256. In addition, assume that four classes (for example, classes 0, 2, 4, and 5) belong to upper class A and two (for example, classes 1 and 3) belong to upper class B.

In that case, the classifier 112 is composed of a 4-class classification model for one resolution (for example, 16) and a 2-class classification model for the other resolution (for example, 256).

The model switching unit 113 inputs the resolution predicted by the resolution predictor 102. The model switching unit 113 instructs the classifier 112 to use the learning model corresponding to the input resolution. Specifically, the model switching unit 113 switches the learning model to be used when the resolution changes. In the classifier 112, the switched learning model performs prediction (for example, classification).

The processing of the training phase of the inference device 110 is the same as the operation of the inference device 100 of the first example embodiment (see FIGS. 3 and 5).

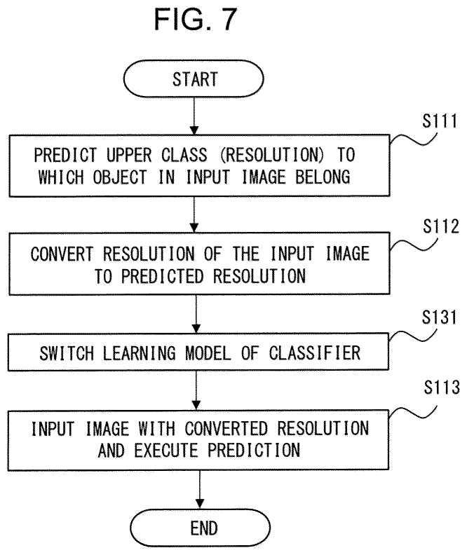

Next, the process in the inference phase will be explained with reference to FIG. 7. FIG. 7 is a flowchart showing an example of an operation of the inference device 110 in the inference phase.

The process of steps S111 and S112 is the same as in the first example embodiment shown in FIG. 4. In this example embodiment, the model switching unit 113 switches the learning model used in the classifier 112 when the resolution changes (step S131).

The process in step S113 is basically the same as the process in the first example embodiment shown in FIG. 4, but in this example embodiment, the learning model after switching in classifier 112 predicts the class using the input image whose resolution has been converted.

Since the number of classes to be classified by the learning model in the classifier 112 is reduced in this example embodiment, the difficulty of the task is expected to be reduced and inference accuracy is expected to be improved. In addition, the architecture of the learning model can be simplified.

### Modification 1

In the above example embodiment, the resolution predictor 102 trains before the inference phase of the classifier 112 begins, or at a predetermined time in the inference phase. The resolution predictor 102 may include a function to search for an architecture of a prediction model that predicts which of the upper classes the objects in the input image belong to, when training.

The resolution predictor 102, for example, performs the architecture search as follows.

As an example, the resolution predictor 102 trains the neural network structure comparable to the neural network structure of the learning model in the classifier 112, and performs the architecture search with reference to the inference accuracy by the classifier 112. For example, the resolution predictor 102 gradually simplifies the neural network structure of the prediction model with the same level of structure as the learned model in the classifier 112. Simplification is to reduce the number of layers and channels. Then, the resolution predictor 102 stops simplifying when the inference accuracy falls below a pre-determined tolerance. The resolution predictor 102 uses the neural network structure at that point as the new neural network structure for the predictor.

As another example, the resolution predictor 102 optimizes the neural network structure such as a hyperparameter, using a method such as Bayesian optimization.

In addition, as another example, resolution predictor 102 may optimize the neural network structure using general NAS (Neural Architecture Search) technique.

### Modification 2

The inference devices 100, 110 of each of the above example embodiments may be applied to a wireless sensing system. A wireless sensing system is a system that identifies objects using received radio waves. For example, as a wireless sensing system, there is a type of system that identifies transmitters in a radio wave environment. As another type of wireless sensing system, there is a system that detects objects based on the radio wave situation affected by the electromagnetic waves hitting the objects. The following is an example of a wireless sensing system that identifies a transmitter.

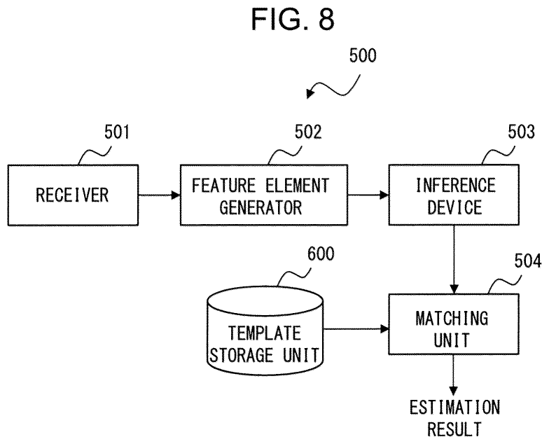

FIG. 8 is an explanatory diagram showing an example configuration of a wireless sensing system. The wireless sensing system 500 shown in FIG. 8 includes a receiver 501, a feature element generator 502, an inference device 503, a matching unit 504, and a template storage unit 600.

The receiver 501 receives electromagnetic waves. The feature element generator 502 extracts feature elements (characteristic elements) from signals based on the received electromagnetic waves. The receiver 501 can extract feature elements from the spectrum of the received wave or the intensity change of the spectrogram, for example.

The inference device 100 of the first example embodiment or the inference device 110 of the second example embodiment can be used as the inference device 503.

The matching unit 504 estimates a transmitter by comparing the prediction result of the inference device 503 with the templates stored in the template storage unit 600. In other words, the matching unit 504 can identify the transmitter by template matching.

When the inference device 100 of the first example embodiment is used as the inference device 503, the classifier 112 is capable of handling multiple input resolutions and the number of dimensions of its output is always constant. Therefore, template matching can be easily performed.

When the inference device 110 of the second example embodiment is used, the learning model is switched. Since the number of output dimensions of the inference unit differs for each learning model, it is necessary to align the number of dimensions of the output of the classifier 112 with the number of dimensions of the templates stored in the template storage unit 600. In other words, the dimensionality of the output of the classifier 112 needs to be adjusted.

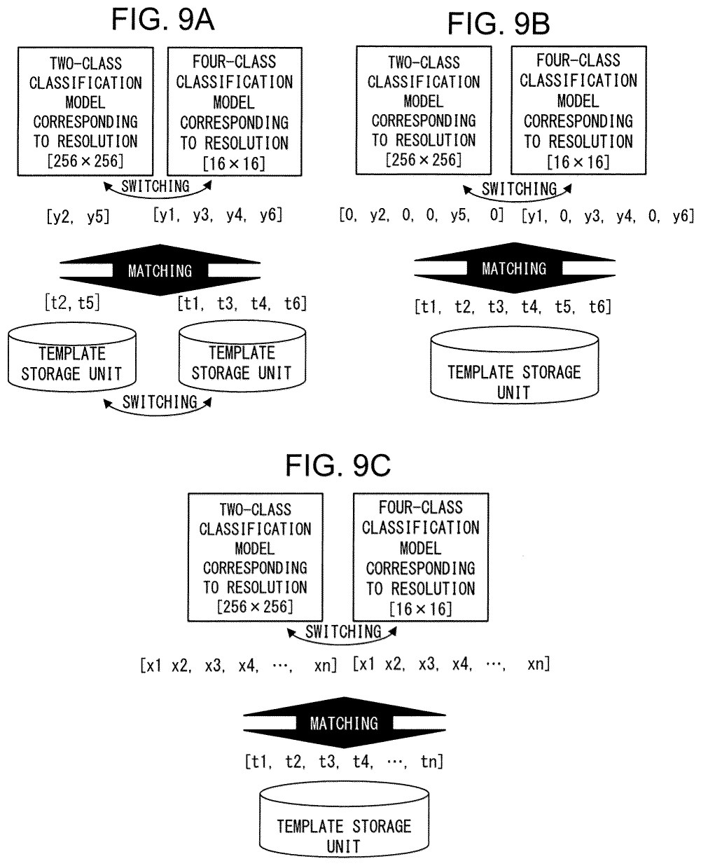

FIG. 9A to FIG. 9C are explanatory diagrams showing how to adjust the number of dimensions of an output from the classifier 112. In FIG. 9A to FIG. 9C, “y” represents elements of a vector output by the classifier 112. “x” represents an output from the layer immediately before the output layer of the learning model included by the classifier 112.

In the method shown in FIG. 9A, multiple template storage units are prepared according to the resolution, and the template storage unit is switched according to the predicted resolution, similar to the switching of the learning model in the classifier 112. In this case, a template storage unit switching unit is provided in the wireless sensing system 500.

In the method shown in FIG. 9B, the classifier 112 outputs the dimension corresponding to the non-applicable class as 0 so that the number of the dimensions of the prediction results of the classifier 112 is equal to the number of dimensions of the template.

In the method shown in FIG. 9C, the number of nodes in the layer before one of the output layer in each learning model (n in the example shown in FIG. 9C) is unified, and the classifier 112 outputs the value of that layer in the inference phase.

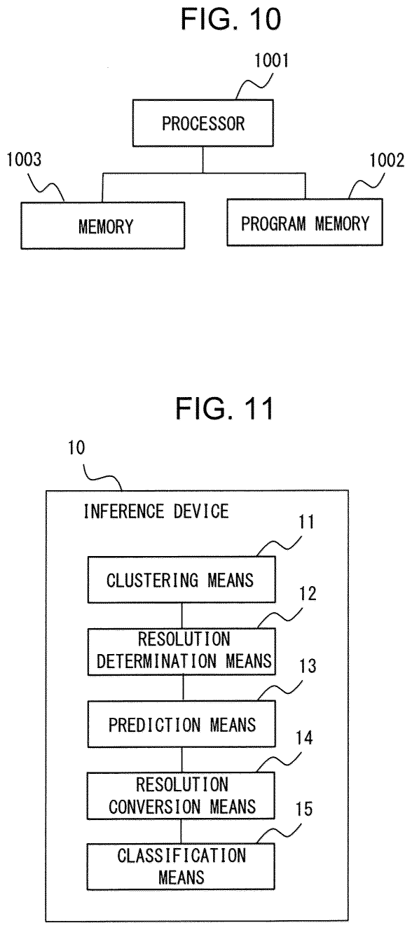

FIG. 10 is a block diagram showing an example configuration of an information processing device (computer) that can realize the functions of the inference devices 100, 110 of the above example embodiments. The information processing device shown in FIG. 10 includes one or more processors such as one or more CPUs (Central Processing Units), a program memory 1002, and a memory 1003. FIG. 10 shows an example of an information processing device with one processor 1001.

The program memory 1002 is, for example, a non-transitory computer readable medium. Non-transitory computer readable media include various types of tangible storage media. For example, a semiconductor storage medium such as a flash ROM (Read Only Memory) or a magnetic storage medium such as a hard disk can be used as program memory 1002. The program memory 1002 stores an inference program to realize the functions of each block (the upper class determination unit 101, the resolution predictor 102, the learning unit 103, the resolution converter 111, the classifier 112, the model switching unit 113) in the inference devices 100, 110 of the above example embodiments.

The processor 1001 realizes the functions of the inference devices 100, 110 by executing processing according to the inference program stored in the program memory 1002. When multiple processors are installed, they can also work together to realize the functions of the inference devices 100, 110.

For example, a RAM (Random Access Memory) can be used as the memory 1003. The memory 1003 stores temporary data and other data generated when the inference devices 100, 110 are executing processes. It can be assumed that an inference program is transferred to the memory 1003 and the processor 1001 executes processing based on the inference program in the memory 1003. The program memory 1002 and the memory 1003 may be integrated into a single unit.

FIG. 11 is a block diagram showing the main part of the inference device. The inference device 10 (corresponding to the inference device 100 or the inference device 110) shown in FIG. 11 comprises clustering means 11 (in the example embodiments, realized by the upper class determination unit 101) for clustering multiple classes to be classified into multiple upper classes, resolution determination means 12 (in the example embodiments, realized by the upper class determination unit 101) for determining a resolution corresponding to each of the multiple upper classes, prediction means 13 (in the example embodiments, realized by the resolution predictor 102) for predicting the upper class to which the class to be classified in the input image belongs, resolution conversion means 14 (in the example embodiments, realized by the resolution converter 111) for converting the resolution of the input image to a resolution corresponding to the predicted upper class, and classification means 15 (in the example embodiments, realized by the classifier 112) for performing classification on the input image whose resolution has been converted.

In the inference device 10, the classification means 15 may include multiple learning models that perform classification on an input image converted to a resolution corresponding to one of multiple upper classes, and comprise switching means switches (for example, changes the learning model to be used to the learning model corresponding to the upper class B after the change) the learning model used for classification when the upper class predicted by the prediction means 13 is changed (for example, from the upper class A to the upper class B). A part of or all of the above example embodiments may also be described as, but not limited to, the following supplementary notes.

### Supplementary Note 1

An inference device that converts a resolution of an input image and performs inference, comprises
clustering means for clustering multiple classes to be classified into multiple upper classes,
resolution determination means for determining a resolution corresponding to each of the multiple upper classes,
prediction means for predicting the upper class to which the class to be classified in the input image belongs,
resolution conversion means for converting the resolution of the input image to a resolution corresponding to the predicted upper class, and
classification means for performing classification on the input image whose resolution has been converted.

### Supplementary Note 2

The inference device according to Supplementary note 1,
wherein the classification means includes multiple learning models that perform the classification on the input image whose resolution is converted to a resolution corresponding to one of the multiple upper classes, and
the inference device comprises switching means for switching the learning model used for classification when the predicted upper class is changed.

### Supplementary Note 3

The inference device according to Supplementary note 1 or 2, comprising calculation means for calculating inference accuracy of each of the multiple classes for each of the multiple resolutions that may be used,
wherein the clustering means performs clustering using the inference accuracy of the class at each of the multiple resolutions.

### Supplementary Note 4

The inference device according to Supplementary note 3, wherein
the resolution determination means determines the resolution corresponding to each of the multiple upper classes based on an average inference accuracy of the multiple classes at the resolution for the number of upper classes selected from the multiple resolutions that may be used, using the inference accuracy.

### Supplementary Note 5

The inference device according to Supplementary note 1 or 2, wherein
the prediction means includes a learning model,
the inference device comprises search means for performing an architecture search of the prediction model when learning the upper class to which the class to be classified in the input image belongs.

### Supplementary Note 6

The inference device according to Supplementary note 1 or 2, wherein
the inference device is incorporated into a wireless sensing system.

### Supplementary Note 7

An inference method comprising:
clustering multiple classes to be classified into multiple upper classes,
determining a resolution corresponding to each of the multiple upper classes,
predicting the upper class to which the class to be classified in the input image belongs,
converting the resolution of the input image to a resolution corresponding to the predicted upper class, and
performing classification on the input image whose resolution has been converted.

### Supplementary Note 8

The inference method according to Supplementary note 7, comprising
switching a learning model among multiple learning models that perform the classification on the input image whose resolution is converted to a resolution corresponding to one of the multiple upper classes.

### Supplementary Note 9

A computer readable storage medium for storing an inference program for converting the resolution of an input image and performing inference and for causing a computer to execute:
clustering multiple classes to be classified into multiple upper classes,
determining a resolution corresponding to each of the multiple upper classes,
predicting the upper class to which the class to be classified in the input image belongs,
converting the resolution of the input image to a resolution corresponding to the predicted upper class, and performing classification on the input image whose resolution has been converted.

### Supplementary Note 10

The computer readable storage medium according to Supplementary note 9, wherein
the inference program causes the computer to execute
switching a learning model among multiple learning models that perform the classification on the input image whose resolution is converted to a resolution corresponding to one of the multiple upper classes.

### Supplementary Note 11

An inference method according to Supplementary note 7 or 8 executed by a computer.

Some or all of the configurations described in Supplementary notes 3 through 6, which are subordinate to Supplementary note 1 described above, can be subordinated to Supplementary notes 7 and 9 according to the same subordination relationship as Supplementary notes 3 through 6. Furthermore, not limited to Supplementary note 1, Supplementary note 7, and Supplementary note 8, some or all of the configurations described in Supplementary notes above may be subordinated to various hardware, software, various recording means for recording software, or systems, provided that no deviation from the example embodiments described above.

What is claimed is:

1. An inference device that converts a resolution of an input image and performs inference, comprising:
a memory storing software instructions, and
one or more processors configured to execute the software instructions to
cluster multiple classes to be classified into multiple upper classes,
determine a resolution corresponding to each of the multiple upper classes,
predict the upper class to which the class to be classified in the input image belongs,
convert the resolution of the input image to a resolution corresponding to the predicted upper class, and
perform classification on the input image whose resolution has been converted.

2. The inference device according to claim 1, wherein
the one or more processors
performs the classification using one of multiple learning models that perform the classification on the input image whose resolution is converted to a resolution corresponding to one of the multiple upper classes, and
switch the learning model used for classification when the predicted upper class is changed.

3. The inference device according to claim 1, wherein
the one or more processors
calculating inference accuracy of each of the multiple classes for each of the multiple resolutions that may be used, and
perform clustering using the inference accuracy of the class at each of the multiple resolutions.

4. The inference device according to claim 3, wherein
the one or more processors
determine the resolution corresponding to each of the multiple upper classes based on an average inference accuracy of the multiple classes at the resolution for the number of upper classes selected from the multiple resolutions that may be used, using the inference accuracy.

5. The inference device according to claim 2, wherein
the one or more processors
calculating inference accuracy of each of the multiple classes for each of the multiple resolutions that may be used, and
perform clustering using the inference accuracy of the class at each of the multiple resolutions.

6. The inference device according to claim 5, wherein
the one or more processors
determine the resolution corresponding to each of the multiple upper classes based on an average inference accuracy of the multiple classes at the resolution for the number of upper classes selected from the multiple resolutions that may be used, using the inference accuracy.

7. The inference device according to claim 1, wherein
the one or more processors
performing prediction the upper class using a learning model, and
perform an architecture search of the prediction model when learning the upper class to which the class to be classified in the input image belongs.

8. The inference device according to claim 2, wherein
the one or more processors
performing prediction the upper class using a learning model, and
perform an architecture search of the prediction model when learning the upper class to which the class to be classified in the input image belongs.

9. The inference device according to claim 1, being incorporated into a wireless sensing system.

10. The inference device according to claim 2, being incorporated into a wireless sensing system.

11. An inference method, implemented by a computer, for converting a resolution of an input image and performing inference, comprising:
clustering multiple classes to be classified into multiple upper classes,
determining a resolution corresponding to each of the multiple upper classes,
predicting the upper class to which the class to be classified in the input image belongs,
converting the resolution of the input image to a resolution corresponding to the predicted upper class, and
performing classification on the input image whose resolution has been converted.

12. The inference method, implemented by the computer, according to claim 11, further comprising
switching a learning model among multiple learning models that perform the classification on the input image whose resolution is converted to a resolution corresponding to one of the multiple upper classes.

13. A non-transitory computer readable storage medium for storing an inference program for converting the resolution of an input image and performing inference and for causing a computer to execute:
clustering multiple classes to be classified into multiple upper classes,
determining a resolution corresponding to each of the multiple upper classes,
predicting the upper class to which the class to be classified in the input image belongs,
converting the resolution of the input image to a resolution corresponding to the predicted upper class, and
performing classification on the input image whose resolution has been converted.

14. The non-transitory computer readable storage medium according to claim 13, wherein
the inference program causes the computer to execute
switching a learning model among multiple learning models that perform the classification on the input image whose resolution is converted to a resolution corresponding to one of the multiple upper classes.
